(19) United States
(12) Patent Application Publication
(10) Pub. No.: US 2009/0177466 A1
(43) Pub. Date: Jul. 9, 2009

(54) DETECTION OF SPEECH SPECTRAL PEAKS AND SPEECH RECOGNITION METHOD AND SYSTEM

(75) Inventors: Zhao RUI, Beijing (CN); Yan XIANG, Beijing (CN); Ding PEI, Beijing (CN); He HEI, Beijing (CN); Hao JIE, Beijing (CN)

Correspondence Address: Charles N.J. Ruggiero, Esq.;Ohlandt, Greeley, Ruggiero & Perle, L.L.P., 10th Floor, One Landmark Square, Stamford, CT, 06901-2682, US

(73) Assignee: KABUSHIKI KAISHA TOSHIBA

(21) Appl. No.: 12/338,867

(22) Filed: Dec. 18, 2008

(30) Foreign Application Priority Data
Dec. 20, 2007 (CN) 200710199194.2

(51) Int. Cl. G10L 19/14

(52) U.S. Cl. 704/225; 704/E19.001

(57) ABSTRACT

The present invention provides a method and apparatus for detecting speech spectral peaks and a speech recognition method and system. The method for detecting speech spectral peaks comprises detecting speech spectral peak candidates from power spectrum of the speech, and removing noise peaks from the speech spectral peak candidates according to peak duration and/or peak positions of adjacent frames, to detect speech spectral peaks. In the present invention, reliable speech spectral peaks can be obtained by removing noise peaks using the limitations of peak duration and adjacent frames in the detection of the speech spectral peaks. Further the energy values of the speech spectral peaks are used to extract the MFCC feature of speech instead of a sample sequence of the whole power spectrum in the conventional technique, the noise robustness of speech recognition can be enhanced while not increasing the speech feature dimensions.

### CROSS-REFERENCE TO RELATED APPLICATIONS

This application is based upon and claims the benefit of priority from prior Chinese Patent Application No. 200710199194.2, filed Dec. 20, 2007, the entire contents of which are incorporated herein by reference.

### BACKGROUND OF THE INVENTION

1. Field of the Invention

The present invention relates to information processing technology, and particularly to detection of speech spectral peaks and speech recognition technique using speech spectral peak information.

2. Description of the Related Art

The Automatic Speech Recognition (ASR) technique is to enable a computer to recognize continuous speech spoken by a person. Usually, the ASR process comprises such two stages as template generation and match recognition. At the template generation stage, templates for comparison are created based on the spectral features of sample speeches; and at the recognition stage, when the speech of a speaker is inputted into the computer, the ASR system of the computer extracts the feature of the speech and compares it with the speech templates stored in advance to find the closest speech sample which matches best, thus obtaining the awareness of the meaning of the input speech and thereby executing a command or converting the speech into a recognition format that the user wishes.

Now, there are proposed many algorithms for the ASR technique, but all these algorithms are generally based on a relatively quiet speech environment. That is, in the current ASR systems, most speech templates are collected/converted from in a quiet environment having no noise.

However, there inevitably exist interferences and noises in a practical speech environment. Thus once there exist interferences and noises in the speech recognition environment and these noises are very strong, the ASR system will be difficult to recognize the speech of a speaker from the speech containing noises, thus the recognition accuracy will be decreased greatly.

Accordingly, although today's ASR systems can obtain satisfying accuracy when used under quiet condition, their performance will degrade dramatically in noisy environments.

Therefore, noise robustness is very important for an ASR system in real application. Further, along with the development and widespread application of the ASR technology, the requirement for noise robustness of speech recognition is becoming stricter, because practical application requires the ASR system must be able to deal with various noise environments.

At present, most of the efforts made for noise robustness issues are concentrated on front-end design in which the aim is to reduce the mismatch in feature space. Since a traditional front-end for speech recognition such as Mel-Frequency Cepstral Coefficients (MFCC) mainly uses power spectrum information of the speech signal while in noisy environments the power spectrum of speech signal often is destroyed by noises, the speech recognition accuracy will be impacted when using the power spectrum destroyed by noises.

Therefore, currently, some improved front-ends use speech spectral peak information which is considered more robust to noise. Although these prior art spectral peak based front-ends have shown their efficiency in improving robustness of ASR system, there are still some problems needed to be solved:

(1) Unwanted noise peaks should be removed. In noisy condition, if noise peaks are wrongly regarded as speech peaks, the performance will be degraded; and

(2) Feature dimensions should not increase too much. Currently, most of the peak based front-ends are composed of feature calculated from spectral peaks and traditional Mel frequency cepstral coefficient (MFCC) features. So the dimensions usually would be increased.

Thus, there is a need for a technique being able to reliably detect speech spectral peaks and use the information of the speech spectral peaks in speech recognition to enhance noise robustness of the speech recognition while not increasing speech feature dimensions.

### BRIEF SUMMARY OF THE INVENTION

The present invention is proposed in view of the above problems in the prior art, the object of which is to provide a method and apparatus for detecting speech spectral peaks and a speech recognition method and system, so as to remove noise peaks by using limitations of peak duration and adjacent frames in the detection of speech spectral peaks to obtain reliable speech spectral peaks, and further to extract the MFCC feature of the speech by using energy values of the reliable speech spectral peaks instead of whole power spectrum in speech recognition, thereby enhancing the noise robustness of speech recognition while not increasing the speech feature dimensions.

According to one aspect of the present invention, there is provided a method for detecting speech spectral peaks, comprising: detecting speech spectral peak candidates from power spectrum of the speech; and removing noise peaks from the speech spectral peak candidates according to peak duration and/or peak positions of adjacent frames, to detect speech spectral peaks.

According to another aspect of the present invention, there is provided a speech recognition method, comprising: by using the method for detecting speech spectral peaks above, detecting speech spectral peaks from power spectrum of a speech to be recognized; and obtaining the MFCC feature of the speech to be recognized by using the information of the speech spectral peaks.

According to another aspect of the present invention, there is provided a speech recognition method, comprising: detecting speech spectral peaks from power spectrum of a speech to be recognized; calculating a spectral peak based vector sequence from the power spectrum of the speech to be recognized by using the information of the speech spectral peaks; and inputting the spectral peak based vector sequence into a Mel filter bank to obtain the MFCC feature of the speech to be recognized.

According to another aspect of the present invention, there is provided an apparatus for detecting speech spectral peaks, comprising: a spectral peak candidate detecting unit configured to detect speech spectral peak candidates from power spectrum of the speech; and a noise peak removing unit configured to remove noise peaks from the speech spectral peak candidates according to peak duration and/or peak positions of adjacent frames, to detect speech spectral peaks.

According to another aspect of the present invention, there is provided a speech recognition system, comprising: the apparatus for detecting speech spectral peaks above, which detects speech spectral peaks from power spectrum of a speech to be recognized; and an MFFC feature extracting unit configured to obtain the MFFC feature of the speech to be recognized by using the information of the speech spectral peaks.

According to another aspect of the present invention, there is provided a speech recognition system, comprising: a spectral peak detecting unit configured to detect speech spectral peaks from power spectrum of a speech to be recognized; a spectral peak based vector obtaining unit configured to calculate a spectral peak based vector sequence from the power spectrum of the speech to be recognized by using the information of the speech spectral peaks; and a Mel filter bank configured to obtain the MFFC feature of the speech to be recognized based on the spectral peak based vector sequence.

### BRIEF DESCRIPTION OF THE SEVERAL VIEWS OF THE DRAWING

It is believed that the features, advantages, and objectives of the present invention will be better understood from the following detailed description of the embodiments of the present invention, taken in conjunction with the drawings, in which:

FIG. 1 is a flowchart of a method for detecting speech spectral peaks according to an embodiment of the present invention;

FIG. 2 is a flow chart of a speech recognition method according to an embodiment of the present invention;

FIG. 3 is a flow chart of a speech recognition method according to another embodiment of the present invention;

FIG. 4 is a block diagram of an apparatus for detecting speech spectral peaks according to an embodiment of the present invention;

FIG. 5 is a block diagram of a speech recognition system according to an embodiment of the present invention; and

FIG. 6 is a block diagram of a speech recognition system according to another embodiment of the present invention.

### DETAILED DESCRIPTION OF THE INVENTION

Next, a detailed description of each preferred embodiment of the present invention will be given with reference to the drawings.

First, the method for detecting speech spectral peaks of the present invention will be described. The main concept of the method for detecting speech spectral peaks of the present invention is to remove noise peaks in power spectrum of speech with limitations of peak duration and peak positions of adjacent frames, so as to detect reliable speech spectral peaks.

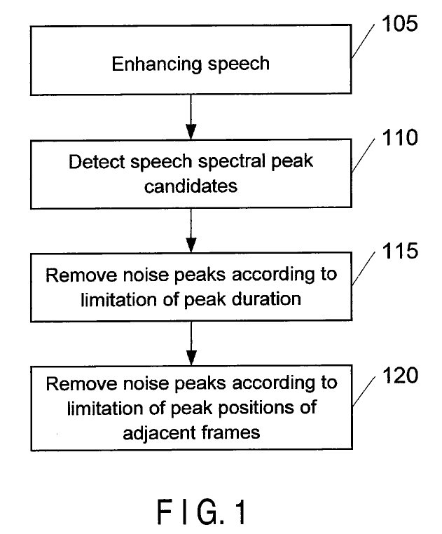

FIG. 1 is a flowchart of a method for detecting speech spectral peaks according to an embodiment of the present invention. As shown in FIG. 1, first at step 105, power spectrum of a speech is enhanced by using a speech enhancement technique. For a speech signal containing noise, since in some cases there is no great difference between the spectrum of the noise and that of the effective speech, if the detection of speech spectral peaks is performed directly, then the detection result will not be very accurate, while after the speech signal is enhanced, the difference between the effective speech signal and the noise will become more obvious, thus facilitating the detection of the effective speech spectral peaks and removal of noise peaks therein. Therefore, prior to detecting speech spectral peaks, the power spectrum of the speech is enhanced by using this step, so that the detection reliability of the speech spectral peaks will be assured in a certain extent.

At this step, in order to implement the enhancement of the speech signal, any speech enhancement techniques presently known or future knowable such as Spectral Subtraction (SS), Minimum Mean-Square Error (MMSE) or Winer Fliter (WF) can be used, and there is no special limitation on this in the present invention.

Next at step 110, spectral peak candidates are detected from the power spectrum of the speech. The object of step 110 is to determine positions of all possible speech peaks in the power spectrum of the speech. For a speech signal, its power spectrum is a wave curve having many “inflexion points” representing peak positions. Thus At this step, the positions of possible speech spectral peaks are determined by determining these “inflexion points” in the speech power spectrum. So calling possible speech spectral peaks is for that there may be peaks generated due to noises among them. Thereby, the possible speech spectral peaks determined at this step are only used as speech spectral peak candidates, and reliable speech spectral peaks are to be screened out further therefrom at subsequent steps.

Next, at step 115, the noise peaks among the speech spectral peak candidates determined at step 110 are removed according to peak duration of the speech power spectrum.

At this step, the removal of the noise peaks among the speech spectral peak candidates is performed based on one of the characteristics of power spectrum of speech signal. That is, in power spectrum of speech signal, the distance between two adjacent speech spectral peaks should be larger than a certain threshold. Thus according to this characteristic, if one or more peaks among the speech spectral peak candidates can be determined to be speech spectral peaks, then the peaks appeared in the threshold distance on the left or right of the speech spectral peak(s) will possibly be peaks of noise signals. Thus at this step, these unreliable peaks will be removed from the speech spectral peak candidates, regarded as noise peaks.

Specifically, in the implementation of the step, the following fact is considered: among the speech spectral peak candidates, generally, the peak having the highest energy is that of the speech signal. So at this step, first it is assumed that the peak having the highest energy among the speech spectral peak candidates is from speech, thus determining the position of the peak having the highest energy; then with the peak having the highest energy as the center, the speech spectral peak candidates are searched in left and right directions along frequency axis by using a search algorithm so as to find peaks whose distances to their respective previous peaks are less than a preset peak duration threshold and remove them from the speech spectral peak candidates as noise peaks. It should be noted that at the step, the adopted search algorithm may be any dynamic programming algorithm presently known or future knowable, and there is no any special limitation on this in the present invention.

In addition, at this step, the power spectrum of speech may also be segmented, and the removal of noise peaks is performed according to the above process with respect to the speech spectral peak candidates in each segment. For example, in the manner of frame by frame, the peak having the highest energy among the speech spectral peak candidates in a same frame may be determined, and with the peak having the highest energy as the center, the noise peaks whose distances to their respective previous peaks are less than the preset peak duration threshold in the frame are removed. In addition, at this step, depending on specific condition, a plurality of peaks whose energies are higher than a preset threshold may all be taken as the peaks having the highest energy as the same time, and with the positions of these peaks as references, the noise peaks are removed by using the limitation of peak duration threshold, respectively.

At step 120, according to the peak positions of adjacent frames in the speech power spectrum, the noise peaks among the speech spectral peak candidates are removed.

At this step, the removal of the noise peaks among the speech spectral peak candidates is performed based on another characteristic of power spectrum of speech signal. That is, in power spectrum of speech signal, the positions of speech spectral peaks between two adjacent frames will not change rapidly, i.e., between two adjacent frames, the positions of speech spectral peaks should correspond to each other or nearly correspond to each other. Frame is a basic unit of signal process or signal transmission in the computer technology. In animation field, a static picture is a frame. In data transmission field, the data transmitted at a time is a frame. In the speech recognition field, due to that a speech signal is a steady short-time signal, there is a need to divide it into a plurality of smaller units and perform analysis on each of the smaller units during recognition process on it. In the speech recognition field, a basic unit of speech recognition process is frame. In generally, the time length of a frame is tens of millisecond in the speech recognition field.

Thus, at this step, the positions of the speech spectral peak candidates in adjacent frames among the speech spectral peak candidates are compared with each other to remove the peaks which appear in one of the adjacent frames but do not appear at the identical positions or adjacent positions in the other frame. That is, the peak positions of speech spectral peak candidates are compared between every two adjacent frames, and the peaks, whose positions deviate a value greater than a threshold in compared with the corresponding peaks in the adjacent frame, are removed from the speech spectral peak candidates, as noise peaks.

The above is a detailed description of the method for detecting speech spectral peaks of the present embodiment. In the present embodiment, reliable speech spectral peaks can be detected by removing noise peaks with the limitations of peak duration and peak positions of adjacent frames in the detection of speech spectral peaks. Further, by enhancing the power spectrum of speech signal first prior to detection of speech spectral peaks, the reliability of the detection of speech spectral peaks can be further assured.

In addition, it needs to be noted that while step 105 of enhancing the speech power spectrum by using the speech enhancing technique is included in the present embodiment, the present invention is not limited to this. In other embodiments, even if the power spectrum of the speech signal is not enhanced, a reliable detection effect of effective speech spectral peaks can also be obtained.

It needs also to be noted that while the two noise peak removing ways of step 115 of removing noise peaks according to limitation of peak duration and step 120 of removing noise peaks according to limitation of peak positions of adjacent frames are all included in the present embodiment, the present invention is not limited to this. In other embodiments, it may be that only one of the two ways for removing noise peaks is adopted, in which case, a certain noise peak removing effect can also be achieved. In addition, while the present embodiment is described in the order of step 115 and step 120, it is not limited to this. In other embodiments, it also may be that, the way of step 120 is firstly used to remove noise peaks according to the limitation of peak positions of adjacent frames, and then the way of step 115 is further used to remove noise peaks according to the limitation of peak duration.

A speech recognition method based on speech spectral peak information of the present invention will be described below.

The main concept of the speech recognition method based on speech spectral peak information of the present invention is, in speech recognition, to use the energy values of speech spectral peaks instead of a sample sequence of the whole power spectrum in the conventional technique to extract the MFCC feature of speech, thus enhancing noise robustness of speech recognition while not increasing speech feature dimensions.

First, a speech recognition method using the method for detecting speech spectral peaks according to the embodiment described in conjunction with FIG. 1 of the present invention is described in conjunction with the drawings.

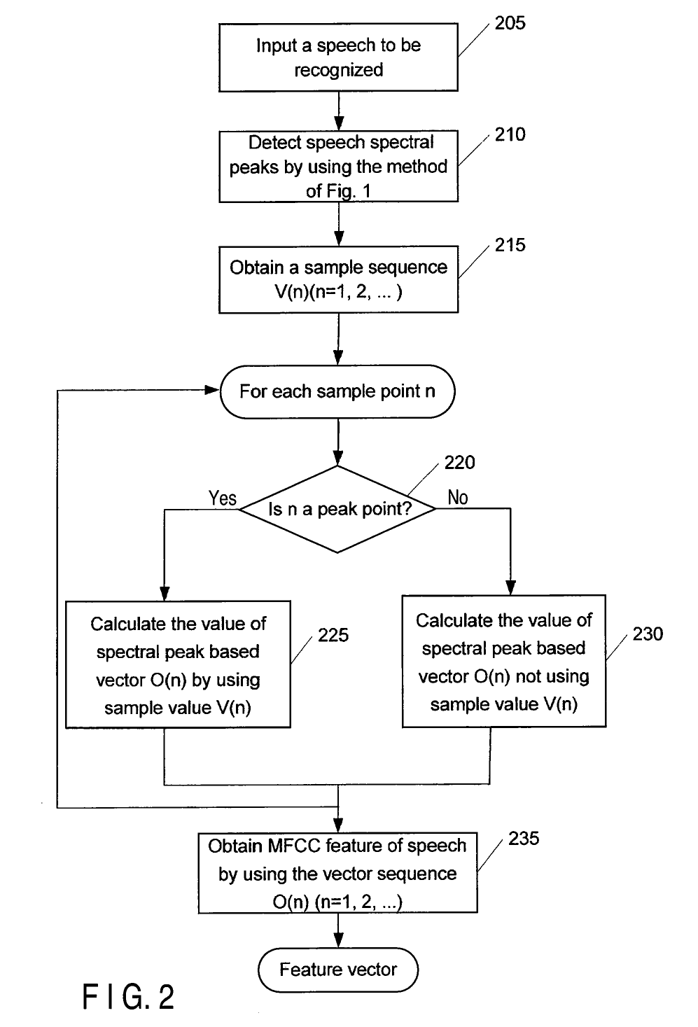

FIG. 2 is a flowchart of a speech recognition method according to an embodiment of the present invention. As shown in FIG. 2, first, at step 205, a speech to be recognized is inputted. Generally, the speech signal to be recognized can be collected through a speaker, and then the power spectrum of the speech can be obtained by FFT.

At step 210, by using the method for detecting speech spectral peaks according to the embodiment described in conjunction with FIG. 1, speech spectral peaks are detected from the power spectrum of the speech to be recognized. At this step, by using the method for detecting speech spectral peaks according to the embodiment described in conjunction with FIG. 1, interferences of noise peaks are removed in a certain extent through limitation of peak duration and limitation of peak positions of adjacent frames, thus speech spectral peaks more reliable for speech recognition are detected.

Next, in the process of the following steps 215-230, by using the information of the speech spectral peaks detected at step 210, a spectral peak based vector sequence o(n)(n=1, 2, . . . ) of the speech to be recognized is obtained.

Specifically, at step 215, a sample sequence v(n)(n=1, 2, . . . ) of the power spectrum of the speech to be recognized is obtained. It is known for a person skilled in the art, a sample sequence of the speech power spectrum is a numerical sequence composed of energy values of a series of points on the speech power spectrum, which is used to represent the analogue power spectrum of the speech.

At step 220, by using the information of the speech spectral peaks detected at step 210, for each sample points n in the sample sequence v(n)(n=1, 2, . . . ), it is determined whether it is located at a peak point position. If so, the process proceeds to step 225, otherwise the process proceeds to step 230.

At step 225, for each sample point n which is determined to be located at a peak point position at step 220, the value of the spectral peak based vector o(n) of the point is calculated by directly using the sample value (energy value) v(n) of the point.

That is, since the spectral peaks detected at step 210 are considered to be reliable speech spectral peaks, for the sample points located at such peak positions, it can be determined that each of them is one point on the speech signal, thus the sample values (energy values) of the sample points can be used reliably and directly.

Specifically, as an implementation of step 225, the value of the spectral peak based vector o(n) of each sample point n at a peak point position is made directly equal to the sample value v(n) of the sample point n, i.e., o(n)=v(n).

As another implementation of step 225, for each sample point n at a peak point position, it is further determined whether the sample value v(n) of the point is greater than a preset energy threshold; when it is greater than the preset energy threshold, the point is credibly considered to be one point on speech signal indeed, thus the sample value v(n) of the point is used to obtain the value of the spectral peak based vector o(n) of the point; otherwise, the sample value of the point is not used and the value of the vector o(n) of

$$it is made equal to 0 , i . e . , o ( n ) = \{ \begin{matrix} v ( n ) & if v ( n ) > threshold \\ 0 & if v ( n ) \leq threshold\end{matrix} .$$

At step 230, for each sample point n which is determined to be not located at a peak point position at step 220, the sample value v(n) of the point is not used to calculate the value of the spectral peak based vector o(n) of the point.

That is, since only the spectral peaks detected at step 210 are considered to be reliable speech spectral peaks while for other points not located at these peak point positions it is unable to reliably determine they are points on the speech power spectrum, the sample values of these unreliable points are avoided from being used directly.

Specifically, as an implementation of step 230, the value of the spectral peak based vector o(n) of each sample point n not located at a peak point position is made directly equal to 0, i.e., o(n)=0.

As another implementation of step 230, for each sample point n not located at a peak point position, the interpolation of the sample values of the two peak points adjacent to the sample point on the left and right, respectively, is used to obtain the value of the spectral peak based vector o(n) of the sample point, i.e.

$$o ( n ) = \frac{( v ( {k}_{r} ) - v ( {k}_{l} ) )}{{k}_{r} - {k}_{l}} ⋆ ( n - {k}_{l} ) + v ( {k}_{l} )$$

where, kₗ and kᵣ represent the nearest left and right peaks points on the speech power spectrum to the sample point n not located on a peak point position, respectively. Thus, by using the implementation, even if for a sample point not located on a peak point position, the value of its spectral peak based vector can also be obtained based on energy values of peak points.

Thus by using steps 225 and 230, a spectral peak based vector sequence o(n)(n=1, 2, . . . ) of the speech to be recognized can be obtained.

Further, if summarizing the different implementations of steps 225 and 230, the following four different solutions for obtaining the spectral peak based vector sequence o(n)(n=1, 2, . . . ) of a speech to be recognized based on the sample sequence v(n)(n=1, 2, . . . ) of the speech of the present invention can be obtained.

Solution 1: for each sample point n in the sample sequence v(n)(n=1, 2, . . . ), if the sample point n is on a peak point, then the value of the spectral peak based vector of the sample point is set as o(n)=v(n), where v(n) is the sample value of the sample point; otherwise as o(n)=0.

Solution 2: for each sample point n in the sample sequence v(n)(n=1, 2, . . . ), if the sample point n is on a peak point, then the value of the spectral peak based vector

$$o ( n ) = \{ \begin{matrix} v ( n ) & if v ( n ) > threshold \\ 0 & if v ( n ) \leq threshold\end{matrix} ,$$

of the sample point is set as where v(n) is the sample value of the sample point; otherwise as o(n)=0.

Solution 3: for each sample point n in the sample sequence v(n)(n=1, 2, . . . ), if the sample point n is on a peak point, then the value of the spectral peak based vector of the sample point is set as o(n)=v(n), where v(n) is the sample value of the sample point; otherwise the value of the spectral peak based vector o(n) of the sample point is set as equal to the interpolation of the sample values of the two peak points adjacent to the sample point n on the left and right respectively, i.e.:

$$o ( n ) = \frac{( v ( {k}_{r} ) - v ( {k}_{l} ) )}{{k}_{r} - {k}_{l}} ⋆ ( n - {k}_{l} ) + v ( {k}_{l} )$$

where, kₗ and kᵣ represent the nearest left and right peaks points on the speech power spectrum to the sample point n not located at a peak point position, respectively.

Solution 4: for each sample point n in the sample sequence v(n)(n=1, 2, . . . ), if the sample point n is on a peak point, then the value of the spectral peak based vector of the sample point is set as

$$o ( n ) = \{ \begin{matrix} v ( n ) & if v ( n ) > threshold \\ 0 & if v ( n ) \leq threshold\end{matrix} ,$$

where v(n) is the sample value or the sample point; otherwise the value of the spectral peak based vector o(n) of the sample point is set as equal to the interpolation of the sample values of the two peak points adjacent to the sample point n on the left and right respectively, i.e.:

$$o ( n ) = \frac{( v ( {k}_{r} ) - v ( {k}_{l} ) )}{{k}_{r} - {k}_{l}} ⋆ ( n - {k}_{l} ) + v ( {k}_{l} )$$

where, kₗ and kᵣ represent the nearest left and right peaks points on the speech power spectrum to the sample point n not located at a peak point position, respectively.

Next, at step 235, instead of the sample sequence v(n)(n=1, 2, . . . ) of the speech to be recognized in conventional technique, the spectral peak based vector sequence o(n)(n=1, 2, . . . ) of the speech to be recognized obtained at steps 225 and 230 is input into a Mel filter bank to obtain an MFCC feature of the speech. At this step, the extraction process of the MFCC feature is as follows: first the convolution of the input spectral peak based vector sequence o(n)(n=1, 2, . . . ) of the speech to be recognized is obtained by using the Mel filter bank; and then DCT is performed on the energy vectors composed by the outputs of the filters to obtain the final MFCC feature of the speech to be recognized.

The above is a detailed description of the speech recognition method of the present embodiment. In this embodiment, first, speech spectral peaks are detected from the power spectrum of the speech to be recognized by using the method for detecting speech spectral peaks of FIG. 1, then a spectral peak based vector sequence of the speech to be recognized is calculated by using the information of the speech spectral peaks, and instead of the conventional sample sequence, the vector sequence is inputted into the Mel filter bank so as to obtain the MFCC feature. In this way, the present embodiment can obtain more accurate speech feature and further higher accuracy of speech recognition by detecting reliable speech spectral peaks by using the method of FIG. 1, and using only the energy values of the reliable speech spectral peaks in extraction of speech feature. Specifically, the advantages of the present embodiment are as follows:

(1) In noisy environment, the performance of speech recognition can be improved by adopting only reliable energy values of effective speech spectral peaks in the extraction of the MFCC feature of the speech.

(2) The robust spectral peak detection ensures the reliability of the information of speech spectral peaks.

(3) The feature dimensions are not increased, avoiding the increase of computation and memory cost.

A speech recognition method not using the method for detecting speech spectral peaks of the embodiment described in conjunction with FIG. 1 of the present invention will be described below in conjunction with the drawings.

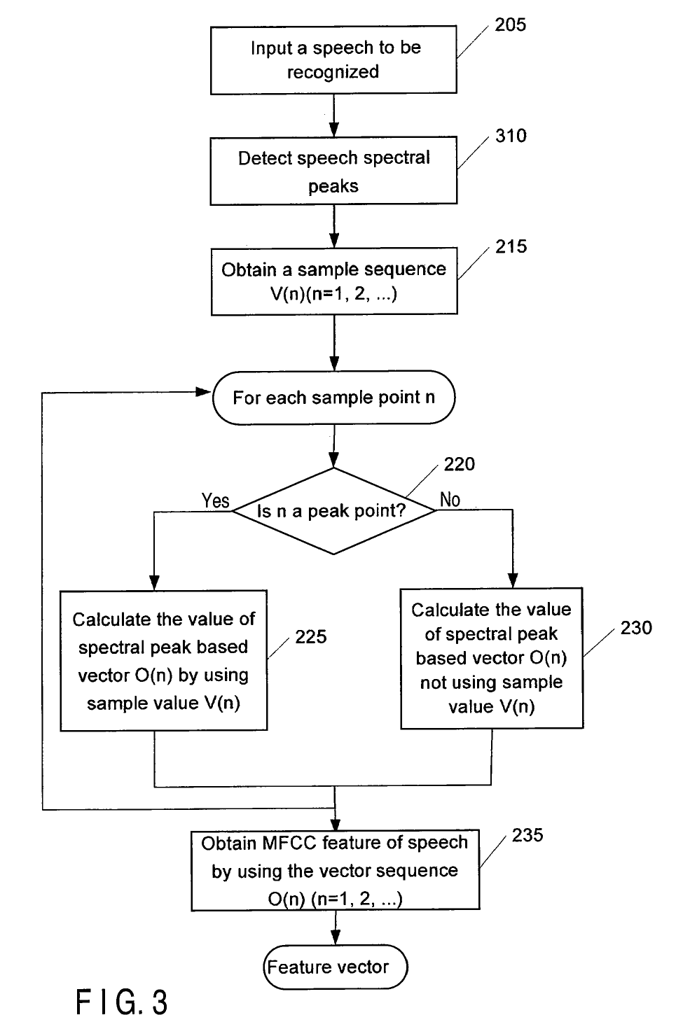

FIG. 3 is a flow chart of a speech recognition method according to another embodiment of the present invention. In the present embodiment, except step 310, all of other steps 205, 215-235 are identical to the steps 205, 215-235 in FIG. 2, so the description of these steps will not be given repeatedly here.

At step 310 of FIG. 3, speech spectral peaks are detected from the power spectrum of the speech to be recognized. At the step, the method for detecting speech spectral peaks of the embodiment described in conjunction with FIG. 1 is not used, instead, except the method, any means presently known or future knowable that capable of detecting speech spectral peaks reliably from the power spectrum of the speech to be recognized can be used, and there is no any special limitation on this in the present invention.

The above is a detailed description of the speech recognition method of the present embodiment. Although the method of FIG. 1 is not used, the present embodiment can also achieve the effect of enhancement of noise robustness of speech recognition in the case of not increasing speech feature dimensions by using only energy values of reliable speech spectral peaks to extract MFCC feature of the speech to be recognized.

Under the same invention concept, the present invention provides an apparatus for detecting speech spectral peaks, which will be described below in conjunction with the drawings.

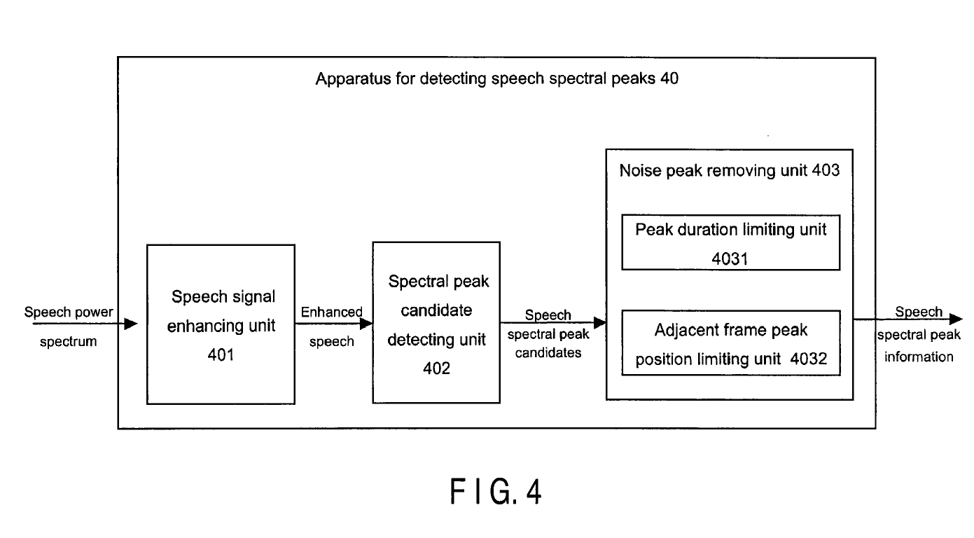

FIG. 4 is a block diagram of an apparatus for detecting speech spectral peaks according to an embodiment of the present invention. As shown in FIG. 4, the apparatus 40 for detecting speech spectral peaks of the present embodiment comprises: speech signal enhancing unit 401, spectral peak candidate detecting unit 402 and noise peak removing unit 403.

The speech signal enhancing unit 401 is configured to enhance the power spectrum of a speech by using a speech enhancing technique. The speech enhancing technique adopted by the speech signal enhancing unit 401 may be any speech enhancement technique presently known or future knowable such as Spectral Subtraction (SS), Minimum Mean-Square Error (MMSE) or Winer Fliter (WF), and there is no any special limitation on this in the present invention.

The spectral peak candidate detecting unit 402 is configured to detect spectral peak candidates from the enhanced power spectrum of the speech. Specifically the spectral peak candidate detecting unit 402 detects inflexion points in power spectrum of the speech as speech spectral peak candidates.

The noise peak removing unit 403 is configured to remove the noise peaks among the speech spectral peak candidates detected by the spectral peak candidate detecting unit 402 according to limitations of peak duration and/or peak positions of adjacent frames.

As shown in FIG. 4, the noise peak removing unit 403 may further comprises peak duration limiting unit 4031 and adjacent frame peak position limiting unit 4032.

The peak duration limiting unit 4031 is configured to determine the peak having the highest energy among the speech spectral peak candidates based on the power spectrum of the speech, and with the peak having the highest energy as the center, remove the peaks whose distances to the previous peaks are less than a preset peak duration threshold from the spectral peak candidates along frequency axis by using a search algorithm. In addition, the peak duration limiting unit 4031 may also, in the manner of frame by frame, determine the peak having the highest energy and further with it as the center, remove the noise peaks which do not satisfy the limitation of peak duration threshold from the speech spectral peak candidates in each frame. In addition, the peak duration limiting unit 4031 may also take a plurality of peaks whose energy values exceed a threshold as the peaks having the highest energy among the speech spectral peak candidates of a frame. In addition, the search algorithm adopted by the peak duration limiting unit 4031 may be any dynamic programming algorithm presently known or future knowable.

The adjacent frame peak position limiting unit 4032 is configured to compare the positions of the speech spectral peak candidates in adjacent frames among the above speech spectral peak candidates with each other, and remove the peaks which appear in one frame but do not appear at the identical positions or adjacent positions in the other frame. That is, the adjacent frame peak position limiting unit 4032 compares the peak positions of speech spectral peak candidates between every two adjacent frames among the speech spectral peak candidates, and removes the peaks whose positions deviate a value greater than a threshold in compared with the corresponding peaks in the adjacent frame from the speech spectral peak candidates, as noise peaks.

The above is a detailed description of the apparatus for detecting speech spectral peaks of the present embodiment. In the present embodiment, reliable speech spectral peaks can be detected by removing noise peaks with the limitations of peak duration and peak positions of adjacent frames in the detection of speech spectral peaks. Further, by enhancing the power spectrum of speech signal first prior to detection of speech spectral peaks, the reliability of the detection of speech spectral peaks can be further assured.

The apparatus 40 for detecting speech spectral peaks of the present embodiment and its components in this embodiment can be constructed with specialized circuits or chips, and can also be implemented by a computer (processor) executing the corresponding programs. Further, the detecting apparatus 40 of the present embodiment can operationally implement the method for detecting speech spectral peaks of the embodiment described in conjunction with FIG. 1 above.

In addition, it needs to be noted that while the peak duration limiting unit 4031 and the adjacent frame peak position limiting unit 4032 are included simultaneously in the present embodiment, in other embodiments, it may be that only one of them is included, in which case, a certain noise peak removing effect can also be achieved.

A speech recognition system adopting the above apparatus 40 for detecting speech spectral peaks of the present invention will be described in conjunction with the drawings.

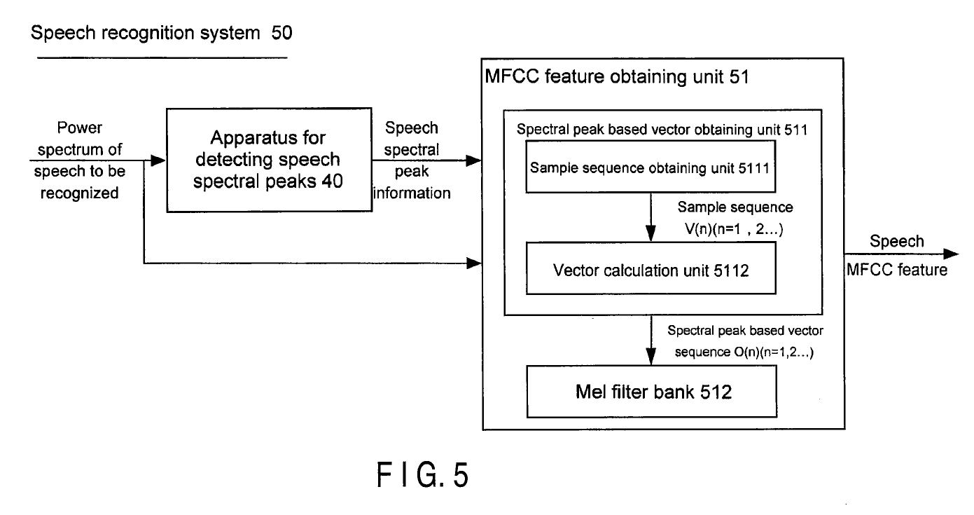

FIG. 5 is a block diagram of a speech recognition system according to an embodiment of the present invention. As shown in FIG. 5, the speech recognition system 50 of the present embodiment comprises: the apparatus 40 for detecting speech spectral peaks of the embodiment described in conjunction with FIG. 4, which detects speech spectral peaks from power spectrum of a speech to be recognized; and MFCC feature obtaining unit 51 configured to obtain the MFCC feature of the speech to be recognized by using the information of the speech spectral peaks obtained by the apparatus 40 for detecting speech spectral peaks.

As shown in FIG. 5, the MFCC feature obtaining unit 51 may further comprises: spectral peak based vector obtaining unit 511 configured to calculate a spectral peak based vector sequence o(n)(n=1, 2, . . . ) from the power spectrum of the speech to be recognized by using the information of speech spectral peaks; and Mel filter bank 512 configured to obtain the MFCC feature of the speech to be recognized based on the spectral peak based vector sequence o(n)(n=1, 2, . . . ).

As shown in FIG. 5, the spectral peak based vector obtaining unit 511 may further comprises: sample sequence obtaining unit 5111 configured to obtain a sample sequence v(n)(n=1, 2, . . . ) of the power spectrum of the speech to be recognized; and vector calculating unit 5112 configured to obtain the spectral peak based vector sequence o(n)(n=1, 2, . . . ) of the speech to be recognized based on the sample sequence v(n)(n=1, 2, . . . ) by using the information of the speech spectral peaks.

Specifically, the vector calculating unit 5112 may obtain the spectral peak based vector sequence o(n)(n=1, 2, . . . ) based on the sample sequence v(n)(n=1, 2, . . . ) of the speech to be recognized according to any one of the following four solutions of the present invention.

Solution 1: for each sample point n in the sample sequence v(n)(n=1, 2, . . . ), it is determined whether the sample point is a peak point:

if the sample point n is a peak point, then the value of the spectral peak based vector of the sample point is set as o(n)=v(n), where v(n) is the sample value of the sample point; otherwise as o(n)=0.

Solution 2: for each sample point n in the sample sequence v(n)(n=1, 2, . . . ), it is determined whether the sample point is a peak point:

if the sample point n is a peak point, then the value of the spectral peak based vector of the sample point is set as

$$o ( n ) = \{ \begin{matrix} v ( n ) & if v ( n ) > threshold \\ 0 & if v ( n ) \leq threshold\end{matrix} ,$$

where v(n) is the sample value of the sample point; otherwise as o(n)=0.

Solution 3: for each sample point n in the sample sequence v(n)(n=1, 2, . . . ), it is determined whether the sample point is a peak point:

if the sample point n is a peak point, then the value of the spectral peak based vector of the sample point is set as o(n)=v(n), where v(n) is the sample value of the sample point; otherwise the value of the spectral peak based vector o(n) of the sample point is set as equal to the interpolation of the sample values of the two peak points adjacent to the sample point n on left and right respectively, i.e.:

$$o ( n ) = \frac{( v ( {k}_{r} ) - v ( {k}_{l} ) )}{{k}_{r} - {k}_{l}} ⋆ ( n - {k}_{l} ) + v ( {k}_{l} )$$

where, kₗ and kᵣ represent the nearest left and right peaks points on the speech power spectrum to the sample point n, respectively.

Solution 4: for each sample point n in the sample sequence v(n)(n=1, 2, . . . ), it is determined whether the sample point is a peak point:

if the sample point n is a peak point, then the value of the spectral peak based vector of the sample point is set as

$$o ( n ) = \{ \begin{matrix} v ( n ) & if v ( n ) > threshold \\ 0 & if v ( n ) \leq threshold ,\end{matrix}$$

where v(n) is the sample value of the sample point; otherwise the value of the spectral peak based vector o(n) of the sample point is set as equal to the interpolation of the sample values of the two peak points adjacent to the sample point n on the left and right respectively, i.e.:

$$o ( n ) = \frac{( v ( {k}_{r} ) - v ( {k}_{l} ) )}{{k}_{r} - {k}_{l}} ⋆ ( n - {k}_{l} ) + v ( {k}_{l} )$$

where, kₗ and kᵣ represent the nearest left and right peaks points on the speech power spectrum to the sample point n, respectively.

The above is a detailed description of the speech recognition system of the present embodiment. In the present embodiment, by using the apparatus 40 for detecting speech spectral peaks described in conjunction with FIG. 4, reliable speech spectral peaks can be detected, further by using only the energy values of the reliable speech spectral peaks in the extraction of speech feature, the obtained speech feature is more accurate, and the accuracy of speech recognition is higher. Specifically, the advantages of the present embodiment are as follows:

(1) In noisy environment, the performance of speech recognition can be improved by adopting only reliable energy values of effective speech spectral peaks in the extraction of the MFCC feature of the speech.

(2) The robust spectral peak detection ensures the reliability of the information of speech spectral peaks.

(3) The feature dimensions are not increased, avoiding the increase of computation and memory cost.

The speech recognition system not adopting the apparatus 40 for detecting speech spectral peaks described above of the present invention will be described below in conjunction with the drawings.

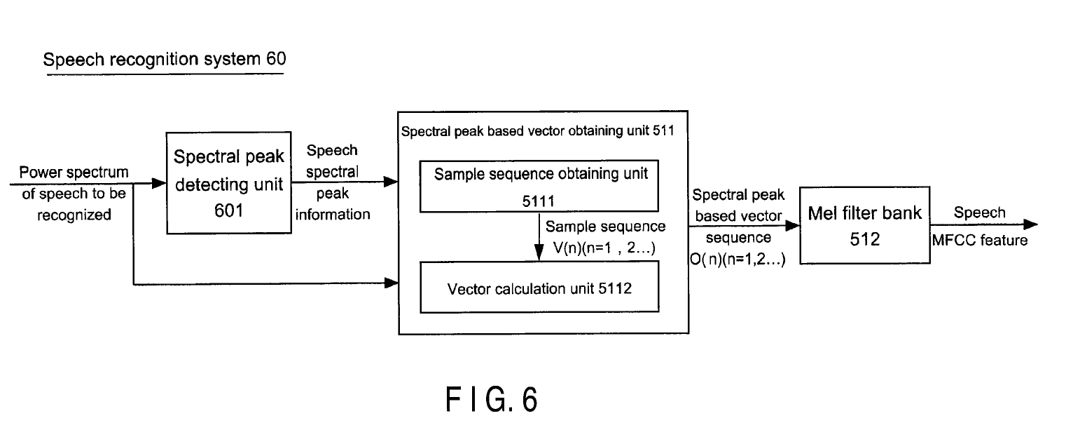

FIG. 6 is a block diagram of a speech recognition system according to another embodiment of the present invention. As shown in FIG. 6, the speech recognition system 60 of the present embodiment comprises spectral peak detecting unit 601, spectral peak based vector obtaining unit 511 and Mel filter bank 512. Moreover, the spectral peak based vector obtaining unit 511 may further comprises sample sequence obtaining unit 5111 and vector calculating unit 5112.

The spectral peak based vector obtaining unit 511, Mel filter bank 512, sample sequence obtaining unit 5111 and vector calculating unit 5112 in the present embodiment are identical to the spectral peak based vector obtaining unit 511, Mel filter bank 512, sample sequence obtaining unit 5111 and vector calculating unit 5112 in FIG. 5, so the description of these units will not be given repeatedly here.

In addition, the spectral peak detecting unit 601 is configured to detect speech spectral peaks from the power spectrum of the speech to be recognized. Different from the apparatus 40 for detecting speech spectral peaks described in conjunction with FIG. 1, the spectral peak detecting unit 601 in the present embodiment may use any means presently known or future knowable that capable of detecting speech spectral peaks reliably from the power spectrum of speech to be recognized, and there is no any special limitation on this in the present invention.

The above is a detailed description of the speech recognition system of the present embodiment. Although the apparatus 40 for detecting speech spectral peaks of FIG. 4 is not included, the present embodiment can also achieve the effect of enhancement of noise robustness of speech recognition in the case of not increasing speech feature dimensions by using only energy values of reliable speech spectral peaks to extract MFCC feature of the speech to be recognized.

While the method and apparatus for detecting speech spectral peaks as well as the speech recognition method and system of the present invention have been described in detail with some exemplary embodiments, these embodiments are not exhaustive, and those skilled in the art may make various variations and modifications within the spirit and scope of the present invention. Therefore, the present invention is not limited to these embodiments; rather, the scope of the present invention is solely defined by the appended claims.

1. A method for detecting speech spectral peaks, comprising:
detecting speech spectral peak candidates from power spectrum of the speech; and
removing noise peaks from the speech spectral peak candidates according to peak duration and/or peak positions of adjacent frames, to detect speech spectral peaks.

2. The method for detecting speech spectral peaks according to claim 1, wherein the step of detecting speech spectral peak candidates from power spectrum of the speech further comprises:
deriving inflexion points of the speech power spectrum as the speech spectral peak candidates.

3. The method for detecting speech spectral peaks according to claim 1, wherein the step of removing noise peaks from the speech spectral peak candidates according to peak duration and/or peak positions of adjacent frames further comprises:
determining peaks having the highest energy among the speech spectral peak candidates based on the speech power spectrum; and
with the peaks having the highest energy as centers, removing the peaks whose distances to the previous peaks are less than a peak duration threshold among the spectral peak candidates.

4. The method for detecting speech spectral peaks according to claim 1, wherein the step of removing noise peaks from the speech spectral peak candidates according to peak duration and/or peak positions of adjacent frames further comprises:
comparing the positions of speech spectral peak candidates in adjacent frames among the spectral peak candidates; and
for the speech spectral peak candidates in the adjacent frames, removing the peaks which appear in one of the adjacent frames but do not appear at the identical positions or adjacent positions in the other frame.

5. The method for detecting speech spectral peaks according to claim 1, further comprising the step prior to the step of detecting speech spectral peak candidates from power spectrum of the speech:
enhancing the power spectrum of the speech by using a speech enhancing technique.

6. A speech recognition method, comprising:
by using the method for detecting speech spectral peaks according to claim 1, detecting speech spectral peaks from power spectrum of a speech to be recognized; and
obtaining the MFCC feature of the speech to be recognized by using the information of the speech spectral peaks.

7. The speech recognition method according to claim 6, wherein the step of obtaining the MFCC feature of the speech to be recognized by using the information of the speech spectral peaks further comprises:
by using the information of the speech spectral peaks, calculating a spectral peak based vector sequence from the power spectrum of the speech to be recognized; and
inputting the spectral peak based vector sequence into a Mel filter bank to obtain the MFCC feature of the speech to be recognized.

8. A speech recognition method, comprising:
detecting speech spectral peaks from power spectrum of a speech to be recognized;
calculating a spectral peak based vector sequence from the power spectrum of the speech to be recognized by using the information of the speech spectral peaks; and
inputting the spectral peak based vector sequence into a Mel filter bank to obtain the MFCC feature of the speech to be recognized.

9. The speech recognition method according to claim 7, wherein the step of calculating a spectral peak based vector sequence from the power spectrum of the speech to be recognized by using the information of the speech spectral peaks further comprises:
obtaining a sample sequence of the power spectrum of the speech to be recognized;
for each sample point in the sample sequence, determining whether it is a peak point based on the information of the speech spectral peaks; and
if the sample point is a peak point, then setting the value of the spectral peak based vector of the sample point as o(n)=v(n), where v(n) is the sample value of the sample point; otherwise as o(n)=0.

10. The speech recognition method according to claim 7, wherein the step of calculating a spectral peak based vector sequence from the power spectrum of the speech to be recognized by using the information of the speech spectral peaks further comprises:
obtaining a sample sequence of the power spectrum of the speech to be recognized;
for each sample point in the sample sequence, determining whether it is a peak point based on the information of the speech spectral peaks; and
if the sample point is a peak point, then setting the value of the spectral peak based vector of the sample point as
$$o ( n ) = \{ \begin{matrix} v ( n ) & if v ( n ) > threshold \\ 0 & if v ( n ) \leq threshold\end{matrix} ,$$
where v(n) is the sample value of the sample point; otherwise as o(n)=0.

11. The speech recognition method according to claim 7, wherein the step of calculating a spectral peak based vector sequence from the power spectrum of the speech to be recognized by using the information of the speech spectral peaks further comprises:
obtaining a sample sequence of the power spectrum of the speech to be recognized;
for each sample point in the sample sequence, determining whether it is a peak point based on the information of the speech spectral peaks; and
if the sample point is a peak point, then setting the value of the spectral peak based vector of the sample point as o(n)=v(n), where v(n) is the sample value of the sample point; otherwise setting the value of the spectral peak based vector o(n) of the sample point as equal to the interpolation of the sample values of the two peak points adjacent to the sample point on left and right respectively.

12. The speech recognition method according to claim 7, wherein the step of calculating a spectral peak based vector sequence from the power spectrum of the speech to be recognized by using the information of the speech spectral peaks further comprises:
obtaining a sample sequence of the power spectrum of the speech to be recognized;
for each sample point in the sample sequence, determining whether it is a peak point based on the information of the speech spectral peaks; and
if the sample point is a peak point, then setting the value of the spectral peak based vector of the sample point as
$$o ( n ) = \{ \begin{matrix} v ( n ) & if v ( n ) > threshold \\ 0 & if v ( n ) \leq threshold\end{matrix} ,$$
where v(n) is the sample value of the sample point; otherwise setting the value of the spectral peak based vector o(n) of the sample point as equal to the interpolation of the sample values of the two peak points adjacent to the sample point on the left and right respectively.

13. An apparatus for detecting speech spectral peaks, comprising:
a spectral peak candidate detecting unit configured to detect speech spectral peak candidates from power spectrum of the speech; and
a noise peak removing unit configured to remove noise peaks from the speech spectral peak candidates according to peak duration and/or peak positions of adjacent frames, to detect speech spectral peaks.

14. The apparatus for detecting speech spectral peaks according to claim 13, wherein the spectral peak candidate detecting unit derives inflexion points in the power spectrum of the speech as the speech spectral peak candidates.

15. The apparatus for detecting speech spectral peaks according to claim 13, wherein the noise peak removing unit further comprises:
a peak duration limiting unit configured to determine peaks having the highest energy among the speech spectral peak candidates based on the power spectrum of the speech, and with the peaks having the highest energy as centers, remove the peaks whose distances to the previous peaks are less than a peak duration threshold among the speech spectral peak candidates.

16. The apparatus for detecting speech spectral peaks according to claim 13, wherein the noise peak removing unit further comprises:
an adjacent frame peak position limiting unit configured to compare the positions of speech spectral peak candidates in adjacent frames among the speech spectral peak candidates, and remove the peaks which appear in one of the adjacent frames but do not appear at the identical positions or adjacent positions in the other frame.

17. The apparatus for detecting speech spectral peaks according to claim 13, further comprising:
a speech signal enhancing unit configured to enhance the power spectrum of the speech by using a speech enhancing technique.

18. A speech recognition system, comprising:
the apparatus for detecting speech spectral peaks according to claim 13, which detects speech spectral peaks from power spectrum of a speech to be recognized; and
an MFFC feature extracting unit configured to obtain the MFFC feature of the speech to be recognized by using the information of the speech spectral peaks.

19. The speech recognition system according to claim 18, wherein the MFCC feature obtaining unit further comprises:
a spectral peak based vector obtaining unit configured to calculate a spectral peak based vector sequence from the power spectrum of the speech to be recognized by using the information of the speech spectral peaks; and
a Mel filter bank configured to obtain the MFFC feature of the speech to be recognized based on the spectral peak based vector sequence.

20. A speech recognition system, comprising:
a spectral peak detecting unit configured to detect speech spectral peaks from power spectrum of a speech to be recognized;
a spectral peak based vector obtaining unit configured to calculate a spectral peak based vector sequence from the power spectrum of the speech to be recognized by using the information of the speech spectral peaks; and
a Mel filter bank configured to obtain the MFFC feature of the speech to be recognized based on the spectral peak based vector sequence.

21. The speech recognition system according to claim 19, wherein the spectral peak based vector obtaining unit further comprises:
a sample sequence obtaining unit configured to obtain a sample sequence of the power spectrum of the speech to be recognized; and
a vector calculating unit configured to, for each sample point in the sample sequence, determine whether it is a peak point based on the information of the speech spectral peaks, and
if the sample point is a peak point, then set the value of the spectral peak based vector of the sample point as o(n)=v(n), where v(n) is the sample value of the sample point; otherwise as o(n)=0.

22. The speech recognition system according to claim 19, wherein the spectral peak based vector obtaining unit further comprises:
a sample sequence obtaining unit configured to obtain a sample sequence of the power spectrum of the speech to be recognized; and
a vector calculating unit configured to, for each sample point in the sample sequence, determine whether it is a peak point based on the information of the speech spectral peaks, and
if the sample point is a peak point, then set the value of the spectral peak based vector of the sample point as
$$o ( n ) = \{ \begin{matrix} v ( n ) & if v ( n ) > threshold \\ 0 & if v ( n ) \leq threshold\end{matrix} ,$$
where v(n) is the sample value of the sample point; otherwise as o(n)=0.

23. The speech recognition system according to claim 19, wherein the spectral peak based vector obtaining unit further comprises:
a sample sequence obtaining unit configured to obtain a sample sequence of the power spectrum of the speech to be recognized; and
a vector calculating unit configured to, for each sample point in the sample sequence, determine whether it is a peak point based on the information of the speech spectral peaks, and
if the sample point is a peak point, then set the value of the spectral peak based vector of the sample point as o(n)=v(n), where v(n) is the sample value of the sample point; otherwise set the value of the spectral peak based vector o(n) of the sample point as equal to the interpolation of the sample values of the two peak points adjacent to the sample point on left and right respectively.

24. The speech recognition system according to claim 19, wherein the spectral peak based vector obtaining unit further comprises:
a sample sequence obtaining unit configured to obtain a sample sequence of the power spectrum of the speech to be recognized; and
a vector calculating unit configured to, for each sample point in the sample sequence, determine whether it is a peak point based on the information of the speech spectral peaks, and
if the sample point is a peak point, then set the value of the spectral peak based vector of the sample point as
$$o ( n ) = \{ \begin{matrix} v ( n ) & if v ( n ) > threshold \\ 0 & if v ( n ) \leq threshold\end{matrix} ,$$
where v(n) is the sample value of the sample point; otherwise set the value of the spectral peak based vector o(n) of the sample point as equal to the interpolation of the sample values of the two peak points adjacent to the sample point on the left and right respectively.
